(19) United States
(12) Patent Application Publication
(10) Pub. No.: US 2024/0419946 A1
(43) Pub. Date: Dec. 19, 2024

(54) SYSTEM AND METHOD FOR GENERATING SYNTHETIC COUNTERFACTUALS VIA SPATIOTEMPORAL TRANSFORMERS

(71) Applicant: The Trustees of Princeton University, Princeton, NJ (US)

(72) Inventors: Bhishma Dedhia, Princeton, NJ (US); Roshini Balasubramanian, Knoxville, TN (US); Niraj K. Jha, Princeton, NJ (US)

(73) Assignee: The Trustees of Princeton University, Princeton, NJ (US)

(21) Appl. No.: 18/743,428

(22) Filed: Jun. 14, 2024

Related U.S. Application Data
(60) Provisional application No. 63/521,142, filed on Jun. 15, 2023.

(51) Int. Cl. G06N 3/0455

(52) U.S. Cl. CPC G06N 3/0455

(57) ABSTRACT

Disclosed is a framework called SCouT that employs a Transformer architecture to make counterfactual predictions that can be used in healthcare and other longitudinal decision-making scenarios. The disclosed approach can use longitudinal donors under an intervention to estimate the synthetic counterfactual for other units. The Transformer-based encoder-decoder model uses a causal map, which enables spatial bidirectionality, to autoregressively generate a synthetic control of a target unit.

### CROSS-REFERENCE TO RELATED APPLICATIONS

The present application claims priority to U.S. Provisional Patent Application No. 63/521,142, filed Jun. 15, 2023, the contents of which are incorporated by reference herein.

### STATEMENT REGARDING FEDERALLY SPONSORED RESEARCH OR DEVELOPMENT

This invention was made with government support under Grant No. CCF-2203399 awarded by the National Science Foundation. The government has certain rights in the invention.

### TECHNICAL FIELD

The present disclosure is drawn to transformer models, and specifically, to transformer models that leverage, inter alia, particular positional embeddings, a modified decoder attention mask, and a novel pre-training task to perform spatiotemporal sequence-to-sequence modeling.

### BACKGROUND

Plato's timeless allegory of the Cave is a classical philosophical thought experiment that routinely comes up in discussions of how humans perceive reality and whether there is any higher truth to existence. A group of people live chained to the wall of a cave all their lives, facing a blank wall and watching shadows projected on the wall from objects passing in front of a fire behind them, until one of them is freed. This prisoner imagines what would it be to look around, only to discover the real nature of the world they have perceived through the shadows thus far. The pursuit of this higher truth has enabled us with the ability to be unshackled from the perceived reality and mathematically reason about alternate, imagined perspectives, an ability coined as counterfactual reasoning. Such reasoning abilities form the hallmark of an agent operating in a dynamic environment and allows them to reliably manipulate the world by ascertaining the possible counterfactuals of potential interventions. Examples of such agents and interventions are ubiquitous in healthcare: policymakers enact laws to improve public health, healthcare systems iteratively improve the quality of care they provide, and physicians determine medical treatment plans for their patients. In each of the previous cases, to make a decision, the physicians and policymakers acting as agents need to evaluate the ability of each intervention option in the form of medications and treatment policies to yield the desired results.

Often, there is interest in reliably estimating the effect of an intervention at both the population and individual levels.

### BRIEF SUMMARY

In various aspects, a method for estimating a counterfactual may be provided. The method may include defining an intervention for a target unit and selecting an intervention target unit. The method may include collecting pre-intervention and post-intervention data from donor units that underwent the intervention. The method may include flattening the pre-intervention and post-intervention data from the donor units into sequences. The method may include linearly embedding the sequences to form linearly embedded sequences. The method may include forming a sequence of vectors by injecting temporal embeddings, spatial embeddings, and target embeddings to the linearly embedded sequences. The method may include passing the sequence of vectors to a Transformer-based encoder-decoder model, the Transformer-based encoder-decoder configured to use a causal map and enables spatial bidirectionality to autoregressively generate a synthetic control (sometimes referred to as a counterfactual) of the target unit.

The Transformer-based encoder-decoder model may include an encoder configured to compute a hidden representation for the pre-intervention data and send the hidden representation to a decoder. The decoder may be configured to use the hidden representation and the post-intervention data to autoregressively generate the synthetic control.

The method may include using the synthetic control to increase a speed of A/B testing. The method may include using the synthetic control to plan a medical treatment. The method may include using the synthetic control to predict advertisement outcomes.

In various aspects, a system may be provided. The system may include at least one processing unit. The system may include at least one non-transitory computer readable storage medium storing instructions that, when executed by the at least one processing unit, causes the at least one processing unit to, collectively, perform various steps. In various aspects, the non-transitory computer readable storage medium may be provided by itself.

The steps may include sending an estimated counterfactual request to a provider computing device from a requestor computing device. The counterfactual request may contain a proposed intervention containing pre and post temporal data of a target unit. The steps may include collecting pre-intervention and post-intervention data from donor units. The steps may include flattening the donor units' pre-intervention and post-intervention data into sequences and linearly embedding said data, adding positional information in a form of temporal and spatial embeddings, and distinguish between target and donor units by injecting a target embedding. The steps may include passing a resultant sequence of vectors to a Transformer-based encoder-decoder model. The steps may include using a causal map, which enables spatial bidirectionality, to autoregressively generate a synthetic control of the target unit. The steps may include sending the autoregressively generated synthetic control to the requestor computing device.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic of a system.

FIG. 2 is a flowchart for a method.

FIG. 3 is a schematic providing an overview of the disclosed model.

FIGS. 4A and 4B show a comparison of a Vanilla decoder mask that: enforces temporal causality and modified causal mask (4A), and that additionally allows spatial bidirectionality (4B).

FIG. 5 is an algorithm for a Transformer (X⁻, X⁺, Y⁻, Y⁺)→Ŷ.

FIG. 6 is an algorithm for training and inference.

FIG. 7 is a graph showing a comparison of methods on synthetic vs. true California. It is inferred that the passage of Proposition 99 reduced per-capita cigarette sales from the gap between observed California and the synthetic counterfactual of California.

FIGS. 8A-8F show visualizations of donor attentions for the three layers of the Transformer (FIGS. 8A, 8C, and 8E), where attention is sparse and spread across specific donors, with the sparsity becoming more pronounced in the deeper layers, as well as—for each attention distribution map—a graph showing the top 5 donors that were extracted and plotted against a synthetic counterfactual from the disclosed approach (FIGS. 8B, 8D, and 8F).

FIG. 9 is a graph showing average root mean squared error (RMSE) for post-intervention Pre-Bronchodilator Forced Expiratory Volume to Forced Vital Capacity ratio (PreFF) prediction across different pre-intervention lengths. The disclosed method outperforms prior work on either pre-intervention lengths. Plotted at 90% confidence intervals.

FIGS. 10A and 10B are graphs showing estimates of PreFF for participant 5 in the placebo group using other units in the placebo group as donors, for a pre-intervention length of 35% (10A) and 70% (10B). The vertical double dot-dash line indicates intervention instance.

FIGS. 11A and 11B are graphs showing a tailored prediction for patient 4 under 9-HPT scale metrics for dominant hand (11A) and non-dominant hand (11B). The vertical dashed line indicates the intervention instance. A higher score is associated with a greater degree of disability.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term “or” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

As detailed in the Appendix, disclosed herein are synthetic counterfactuals via spatiotemporal transformers (SCouT) for use with, e.g., healthcare, etc. The disclosed approach employs a Transformer based system that can use longitudinal donors under an intervention to estimate the synthetic counterfactual for other units.

Exemplary immediate applications of the disclosed approach include estimating counterfactuals for public and personalized healthcare systems, namely, disease progress prediction, efficient randomized trials and policy analysis. At a broader level, the disclosed approach can be used for recommender systems and retail forecast analysis.

For example, after a patient is diagnosed with a condition, physicians are faced with the challenge of administering a treatment plan that reliably improves patient wellness. Often healthcare providers rely on heuristic one-size-fits-all treatments; such approaches have been shown to be error-prone. While machine learning is rapidly integrating into the diagnostics fabric of healthcare, robust decision-making remains a distant goal. The disclosed approach shows how one can use state-of-the-art neural network architectures as an in-silico substrate to simulate the effect of various medical interventions and consequently makes an important stride towards personalized medicine.

Some features of the disclosed approach include:
1) Prior works rely on simple linear models that are unamenable to noisy real-life data. On the other hand, here the data is modeled as a sequence abstraction and employed is a type of transformer architecture that can take into account both the patient identity and the patient time series data to predict the outcomes. While prior models can only take continuous numbers as inputs, the disclosed architecture is essentially multimodal and can be trained on discrete classes, text, audio and pictures that constitute clinical, physiological, and genetic history of patients.
2) Along with introducing the disclosed architecture, also disclosed is a training algorithm. Prior works rely on linear regression that tends to overfit on training data. The disclosed architecture uses the backpropagation training method that makes it easy to optimize and endows the model with robustness to noise, sample efficiency, and strong generalization properties to unseen data.
3) The disclosed approach allows the visualization of relationships between donor units and some target unit spread across both space and time. Prior works are time-agnostic and limited to space only. The implication is therefore that the disclosed method allows rapid selection of a subset of patients who match the target patient at that moment in time. This can help physicians facilitate fine-grained treatment planning.
4) The disclosed approach shows the first Transformer based modeling of intervention effects for patients with Friedrich's Ataxia. Prior works cannot model discrete classes or are data-hungry. This prevents them from modeling such rare diseases that have small patient data size and sparsely-present continuous data.

For an intervention of interest, the disclosed approach collects data from units that underwent or have otherwise undergone the same intervention. The data are longitudinal in nature and have time segments both prior to and post intervention. All the donor units are aligned along the intervention time and the SCouT model is learned over this data structure. It can then be fine-tuned on some target of interest over the pre-intervention period to match the donors to the target with the subsequent prediction of the outcome under the intervention.

Typically, a synthetic control (SC) problem to be considered consists of a ‘target’ unit and N ‘donor’ units with N typically small. A unit can refer to an aggregate of a population segment or an individual. N donor units undergo the intervention one is interested in at the same time instance. Without loss of generality, it can be assumed that control assignment is also a type of intervention and finding the counterfactual under control reduces to the SC problem. For each unit, panel data are available for a time period T and the covariate in each panel can have missing data. One can make standard assumptions about the units.

1. Stable Unit Treatment Value Assumption (SUTVA): The potential outcomes for any unit do not vary with the treatments assigned to other units and, therefore, there are no spillover effects.

2. No anticipation of treatment: This implies that the units cannot anticipate the assignment of treatment a priori and, therefore, the assignment has no effect on the pre-intervention trajectory.

3. Exchangeability (No unmeasured confounders): This assumption implies that units that are exposed and unexposed have the same potential outcomes on average and hence in the case of an observational study, a control group can be reliably used to measure the counterfactual of the treatment group.

4. Positivity (Common support): This necessitates covariates in the control and the treatment group have overlapping distributions (common support), in the absence of which it is impossible to understand the causal effect of a treatment because a subset of the population is always entirely left treated or untreated.

Data-generation Process: The underlying data generation of a unit i consists of unit-specific latent θᵢ and time-indexed latents pr. The observation of all covariates of unit i at time t, yᵢₜ, depends on all prior temporal latents and is given by:

$${y}_{it} = {m}_{i t} + {ϵ}_{it} , {ϵ}_{it} ∼ 𝒩 ( 0 , {σ}^{2} ) \qquad ( 1 )$$

$${m}_{it} = f ( {θ}_{i} , {ρ}_{t} , … , {ρ}_{1} ) \qquad ( 2 )$$

Function ƒ is implicitly learned by the Transformer that can capture a wide class of nonlinear autoregressive dynamics. This generalized model that subsumes the models popularly assumed in the literature. In some embodiments, the following model for the data-generation process is assumed:

$${y}_{it} = {ρ}_{t}^{T} {X}_{i} + {ϵ}_{it} \qquad ( 3 )$$

Here, ρₜ denotes the latent at time t and Xᵢ denotes the observed covariates of unit i. Setting ƒ to the linear factor function and θᵢ=Xᵢ in Eq. (2) yields the model defined by Eq. (4). Similarly, in some embodiments, it can be assumed that:

$${y}_{it} = {ρ}_{t}^{T} {C}_{i} + {ϵ}_{it} \qquad ( 3 )$$

where Cᵢ is a latent unit-specific representation. It is straightforward to see that Eq. (2) captures this model as well.

The problem may be set up formally as follows.

The synthetic counterfactual problem uses a ‘target’ unit and N ‘donor’ units. For the SC, the target unit Y is exposed to a treatment or intervention, and the donor units are assumed to be unexposed and, therefore, natural controls. Therefore, for SC, one is interested in the counterfactual of the target under the control assignment. On the contrary, donors are exposed to the intervention at a time instance and are natural controls prior to that instance for computing the synthetic intervention (SI). Therefore, SC and SI are dual problems and simply differ in the type of intervention the donors receive at the intervention instance.

Each unit is T time units long, and at each time step, the sequence has K covariates, e.g., Gross Domestic Product, literacy rate, or physiological data, where each covariate may have missing values. Let each element in the target sequence Y∈ [symbol] ^{T×K} be denoted by y^{t,k}, where t denotes the time instance and k denotes the covariate. Without loss of generality, assume that the covariate of interest is at k=1, and let T₀ be the time of intervention. The target sequence Y=[Y⁻, Y⁺] is thus divided into a pre-intervention sequence Y⁻∈ [symbol] ^{T}^{₀}^{×K} and a post-intervention sequence Y⁺∈R [symbol] ^{(T-T}^{₀}^{)×K}. Let the tensor X∈ [symbol] ^{N×T×K} represent the data from N donor units and y^{i,t,k} represent each element of the donor tensor X, where i is the donor, t is the time instance, and k is the covariate. Let X=[X⁻,X⁺], where X⁻∈ [symbol] ^{N×T}^{₀}^{×K} and X⁺∈ [symbol] ^{N×(T-T}^{₀}^{)×K} denote the pre-intervention and post-intervention data of the donors, respectively. The SC problem involves learning a predictor ƒ_{θ}^{t}(·) for the post-intervention control of the covariate of interest, ŷ^{t,1}∀t∈[T₀+1, . . . , T], using the donor data X and the pre-intervention target sequence Y⁻. More formally:

$${\hat{y}}^{t , 1} = {f}_{θ}^{t} ( X , {Y}^{-} ) , ∀ t ∈ [ {T}_{0} + 1 , … , T ] \qquad ( 5 )$$

Transformers were proposed to model sequential data. They have achieved state-of-the-art results on several NLP tasks. The model consists of stacked layers, where each layer has a self-attention module followed by a feedforward module, and each module has residual connections and layer normalization. The self-attention module learns powerful internal representations that capture important semantic and syntactic associations across input tokens. This module decomposes each token into a query (Q), key (K), and value (V) vector, and uses these vectors to aggregate global information at each sequence position.

In various aspects, a system may be provided. The system may include at least one processing unit and non-transitory computer readable storage medium operably coupled to the processing unit(s).

As used herein, the term “processing unit” generally refers to a computational device capable of accepting data and performing mathematical and logical operations as instructed by program instructions. This may include any central processing unit (CPU), graphics processing unit (GPU), core, hardware thread, or other processing construct known or later developed. The term “thread” is used herein to refer to any software or processing unit or arrangement thereof that is configured to support the concurrent execution of multiple operations.

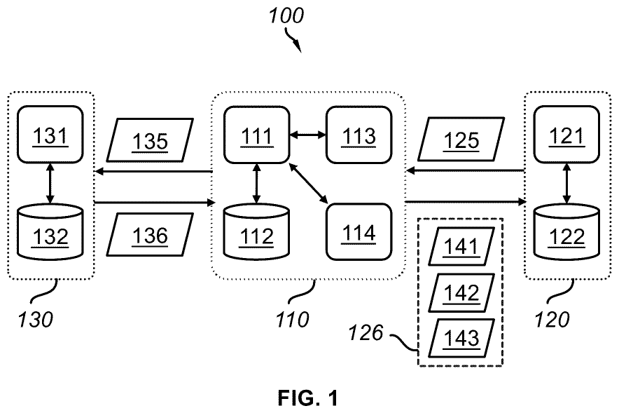

Referring to FIG. 1, a system (100) may include at least one a provider computing device (110). The provider computing device may include one or more processing units (111), one or more non-transitory computer readable storage media (112), memory (113), and one or more input/output devices or connections (114) (such as connections for ethernet, wireless connections, keyboards, displays, etc.).

The system may include a requestor computing device (120). The requestor computing device may include processing unit(s) (121) operably coupled to non-transitory computer-readable storage medium/media (122). The requestor computing device may be configured to send an estimated counterfactual request (125) to a provider computing device, and to receive an autoregressively generated synthetic control (126) from the provider computing device. The provider computing device is therefore configured to receive the estimated counterfactual request (125) from the requestor computing device, and to send the autoregressively generated synthetic control (126) to the requestor computing device.

As shown in FIG. 1, the system may generate counterfactuals across one or more modalities, including, but not limited to, time series graphs (141), symptom classification (142), images (143), etc.

As part of the process, the system may include a remote computing device (130) that is configured to include data, including donor units that may be used during the process. The remote computing device may include processing unit(s) (131) operably coupled to non-transitory computer-readable storage medium/media (132). For example, the provider computing device may be configured to send a data request (135) to a remote computing device, and to receiving data (136) (such as data including donor units) from the remote computing device. The remote computing device is therefore configured to receive the data request (135) from the provider computing device, and to send the data (136) to the requestor computing device.

The non-transitory computer readable storage media may store instructions thereon that, when executed by the at least one processing unit, cause the at least one processing unit to perform a method.

Broadly, the problem may be viewed through the lens of Seq2Seq modeling. For the intervention instance T₀, the counterfactual of the target until time t can be denoted as Ŷ^{t}=[ŷ^{T}^{ₒ},ŷ^{T}^{₀}⁺¹, . . . , ŷ^{t}], and similarly the post-intervention of the donor data until t as X^{+t} ∈ [symbol] ^{N×(t-T}^{₀}^{)×K}. Then the distribution of the synthetic counterfactual can be modeled as:

$$P ( \hat{Y} \vert X , {Y}^{-} ) = {\prod }_{t := {T}_{0} + 1}^{T} {P}_{θ} ( {\hat{y}}^{t} \vert {\hat{Y}}^{t - 1} , {X}^{+ t} , {X}^{-} , {Y}^{-} ) \qquad ( 17 )$$

An encoder-decoder model is used, where the encoder ƒ_{α}(·) computes a hidden representation [symbol] for the pre-intervention data [symbol] Y⁻,X⁻ [symbol] and passes it to the decoder g_{ϕ}(·) that uses the representation and the post-intervention donor data X^{+t} to autoregressively generate the control ŷ^{t}.

$$𝒱 = {f}_{α} ( {X}^{-} , {Y}^{-} ) \qquad ( 18 )$$

$${P}_{θ} ( {\hat{y}}^{t} \vert {\hat{Y}}^{t - 1} , {X}^{+ t} , {X}^{-} , {Y}^{-} ) = {g}_{ϕ} ( {\hat{Y}}^{t - 1} , {X}^{+ t} , 𝒱 ) \qquad ( 19 )$$

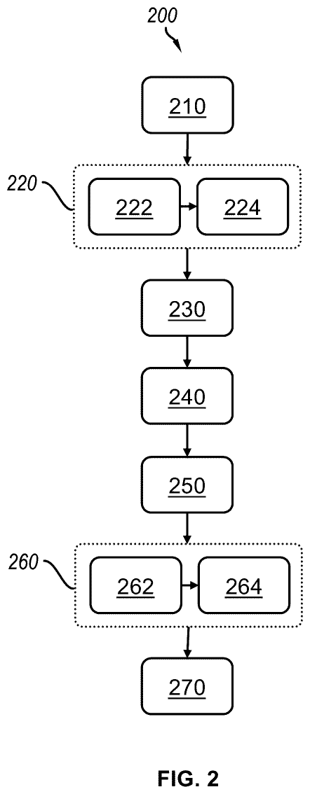

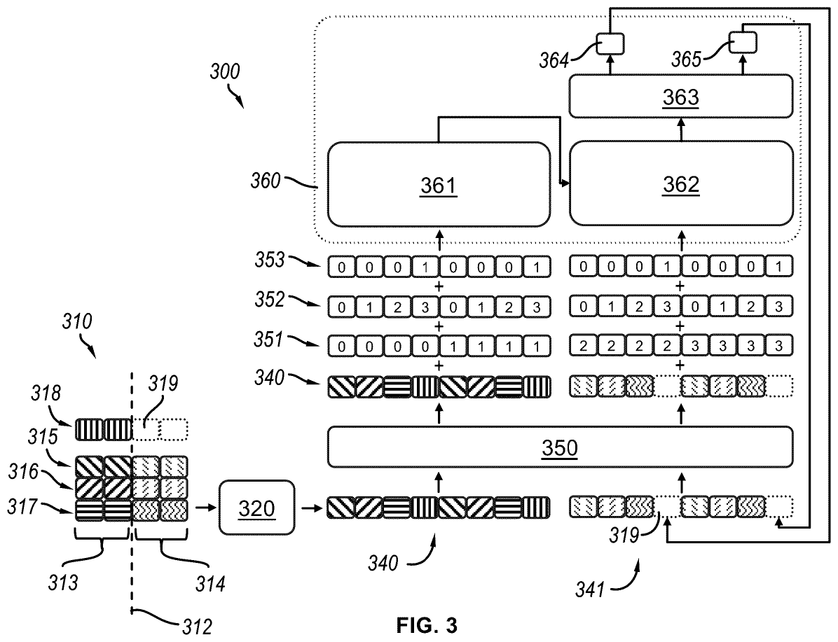

The method may be understood with reference to FIGS. 2 and 3.

The method (200) may include sending (210) an estimated counterfactual request to a provider computing device from a requestor computing device. The counterfactual request may include a proposed intervention containing pre and post temporal data of a target unit.

The method may include preparing data (220). This may include collecting (222) pre-intervention and post-intervention data from donor units. The donor units have previously undergone the intervention. Depending on the quality of the data (such as the pre-intervention data), the method may include pre-processing (224) the data for missing values and filtering out sparse pre-intervention trajectories.

In FIG. 3, a schematic of the model (300) can be seen. The prepared data (310) can be seen, with data from donor 1 (315), donor 2 (316), donor 3 (317) and the target (318) shown, along with data from before an intervention (312) (T₀) (e.g., pre-intervention data (313)) as well as post-intervention data (314). The data (319) for the target that is to be generated by the model is also shown.

The method may include flattening (230) the donor units' pre-intervention and post-intervention data into sequences (pre-intervention sequence (340) and post-intervention sequence (341) are shown). Such techniques are well-understood in the art and are shown as flattening module (320) in FIG. 3.

The method may include linearly embedding (240) the data. Again, such techniques are well-understood in the art; the module configured to do this (using one or more processing units) is shown in FIG. 3 as linear embedding encoder (350).

In one embodiment, an ML algorithm is configured to flatten and embed the data into linearly embedded sequences.

The method may include forming (250) a sequence of vectors by injecting temporal embeddings, spatial embeddings (e.g., adding positional information in the form of temporal and spatial embeddings), and target embeddings (e.g., distinguishing between target and donor units by injecting a target embedding) into the linearly embedded sequences. In FIG. 3, this is shown as the combination of the pre-intervention sequence (340), temporal embedding (351), spatial embedding (352), and target embedding (353).

The method may include sending the resultant sequence of vectors to Transformer-based encoder-decoder model (360). The Transformer-based encoder-decoder model may include a Transformer encoder (361). The Transformer-based encoder-decoder model may include a Transformer decoder (362). The Transformer-based encoder-decoder model may include a linear encoder (363).

The Transformer-based encoder-decoder model be configured to use a causal map, which enables spatial bidirectionality, to autoregressively generate (260) a synthetic control (e.g., SC (364) and/or SC (365) of the target unit.

Said differently, the method may include computing compute (262) (via an encoder) a hidden representation for the pre-intervention data and sending the hidden representation to a decoder. The method may include using the hidden representation and the post-intervention data to autoregressively generate (264) the synthetic control.

As noted, an overview of the Transformer model is given in FIG. 3. It encodes pre-intervention data of temporal length l⁻ and decodes it into post-intervention data of temporal context l⁺. The pre-intervention data of the target and the donors can be represented by the tensor Z⁻=[Y⁻;X⁻]∈ [symbol] ^{(N+1)×l}^{^{−}}^{×K}. Similarly, the post-intervention data are represented by Z⁺=[Ŷ;X⁺]∈ [symbol] ^{(N+1)×l}^{⁺}^{×K}. The standard Transformer receives a 1D sequence of input tokens. Hence, we flatten Z⁻ and Z⁺ are flattened into a ID sequence Z_{flat}⁻∈ [symbol] ^{(N+1)l}^{^{−}}^{×K} and Z_{flat}⁻∈ [symbol] ^{(N+1)l}^{⁺}^{×K} respectively. Each token is then projected into the hidden dimension D of the Transformer via a trainable linear weight Wₑ ∈ [symbol] ^{K×D} to give sequences E⁻∈ [symbol] ^{(N+1)l}^{^{−}}^{×D}. and E⁺ ∈ [symbol] ^{(N+1)l}^{⁺}^{×D}. More precisely,

$${E}^{-} = {Z}_{flat}^{-} {W}_{e} = {[ {x}^{i , t} {W}_{e} , … , {x}^{N , t} {W}_{e} ; {y}^{- t} {W}_{e} ]}_{t = {T}_{0} - {l}^{-} + 1}^{{T}_{0}} \qquad ( 20 )$$

$${E}^{+} = {Z}_{flat}^{+} {W}_{e} = {[ {x}^{i , t} {W}_{e} , … , {x}^{N , t} {W}_{e} ; {\hat{y}}^{t} {W}_{e} ]}_{t = {T}_{0} + 1}^{{T}_{0} + {l}^{+}} \qquad ( 21 )$$

### Positional and Target Embeddings

Each token in the sequence belongs to one of N+1 tokens, one of T time instances, and either a donor or the target unit. Therefore, one can inject a learnable spatial embedding [symbol] ₛₚₐₜᵢₐₗ(·) ∈ [symbol] ^{(N+1)×D}, time embedding [symbol] ₜ(·)∈ [symbol] ^{T×D}, and a target embedding [symbol] target(·)∈ [symbol] ^{2×D} to enable the model to differentiate between spatiotemporal positions of the token in the data matrix as well as separate donors from the target unit. The resultant encoder input H⁻ and the decoder input H⁺ sequences are obtained as follows:

$${H}^{-} = {E}^{-} + {𝔼}_{spatial} ( {E}^{-} ) + {𝔼}_{t} ( {E}^{-} ) + {𝔼}_{target} ( {E}^{-} ) \qquad ( 22 )$$

$${H}^{+} = {E}^{+} + {𝔼}_{spatial} ( {E}^{+} ) + {𝔼}_{t} ( {E}^{+} ) + {𝔼}_{target} ( {E}^{+} ) \qquad ( 23 )$$

### Encoder

A vanilla bidirectional Transformer encoder may be used with a latent dimension D consisting of/stacked identical layers. The encoder processes the input sequence H⁻ and outputs a sequence of representations [symbol] over the input. A key K and value V vector are computed over each of the tokens in [symbol] and passed to the decoder.

### Decoder

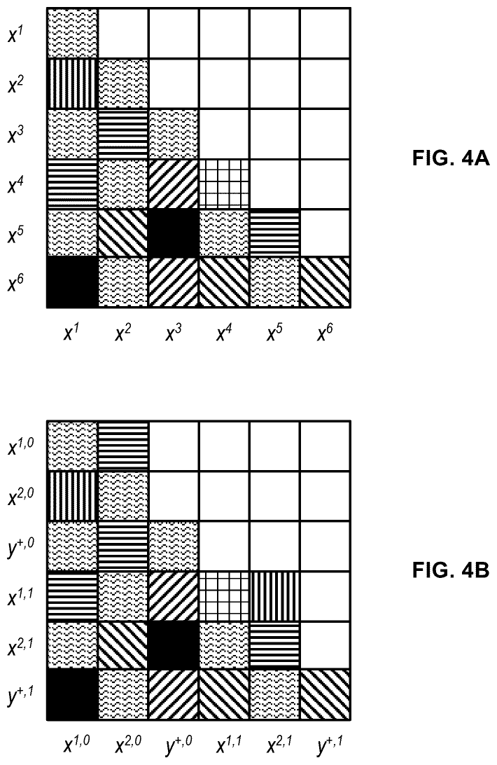

The decoder may be tasked with autoregressively generating the counterfactual Ŷ, given the encoder output [symbol] and sequence H⁺. The decoder design mostly follows the vanilla Transformer decoder with/stacked identical layers. Each layer has two kinds of attention, viz., causal self-attention module that operates over the decoder hidden states and the ‘encoder-decoder’ attention module that operates over the joint representation of the encoder and decoder. However, the causal attention mask used in the self-attention module is modified to account for the tokens that lie on the same temporal slice but differ spatially. In other words, temporal causality is enforced, but bidirectionality spatially is allowed. The modified causal mask for spatiotemporal data is illustrated in FIGS. 4A and 4B. The hidden state of SC is then projected via a linear weight W_{d}∈ [symbol] ^{D×1} to obtain the prediction.

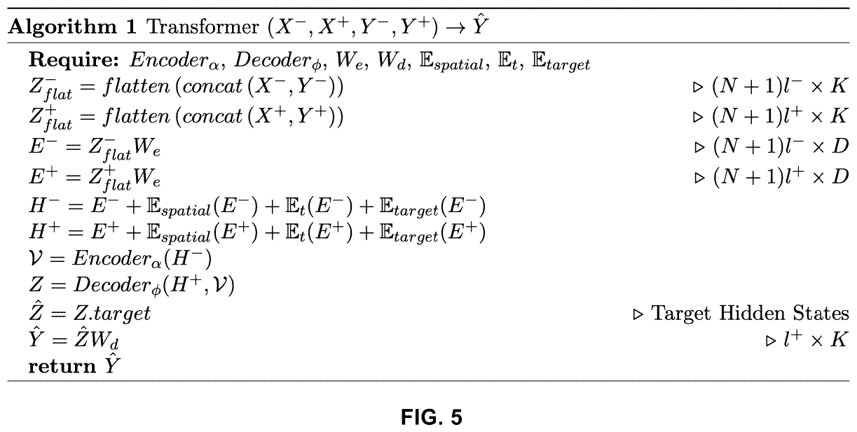

Algorithm 1 (see FIG. 5) lays out the skeleton of the model.

Transformer-based language models are usually pre-trained on an unsupervised task to learn high-capacity representations that help boost downstream performance on discrimination tasks. In the same way, the model may be pre-trained on donor data to reliably reconstruct the counterfactual, the ground truth of which is known. In each training iteration, one can sample a donor unit Xᵢ∈ [symbol] ^{1×T×K}; i∈[1, . . . , N] and an intervention time T′∈[1, . . . , T] are sampled.

The sampled donor may be treated as a pseudo-target and the model may be tasked with generating its post-intervention counterfactual. Let X_{\i}⁻∈ [symbol] ^{(N-1)×1}^{^{−}}^{×K} and X_{\i}⁺∈ [symbol] ^{(N-1)×l}^{⁺}^{×K} denote the pre-intervention and post-intervention donor data excluding the sampled donor, respectively, and let \hat{X}ᵢ^{t}∈ [symbol] ^{(N-1)×(t-T}^{^{l}}^{)×K} denote the post-intervention control of the pseudo-target until time t and \hat{x}ᵢ^{t} be the control at instance t. The objective of the model is to maximize the following log-likelihood:

$$ℒ ( α , ϕ ) = {\sum }_{t = {T}^{′} + 1}^{{T}^{′} + {l}^{+}} log ( P ( {\hat{x}}_{i}^{t} \vert {\hat{X}}_{i}^{t - 1} , {X}_{\backslash i}^{+} , {X}^{-} , α , ϕ ) ) \qquad ( 24 )$$

Here, one can use the teacher forcing algorithm while training and assume a Gaussian model for the likelihood that reduces the loss function to squared error.

### Fine-Tuning

Fine-tuning proceeds by fitting the model on the pre-intervention data Y⁻ of the target unit using the pre-intervention donor data X⁻. In each fine-tuning iteration, a time instance T′ in [1, . . . , T₀] can be sampled for use as the pseudo-intervention instance. Then, one can treat X⁻ and Y⁻ as the data in hand and divide it into pseudo-pre-intervention and pseudo-post-intervention data to predict the pseudo-post-intervention of the target.

### Inference

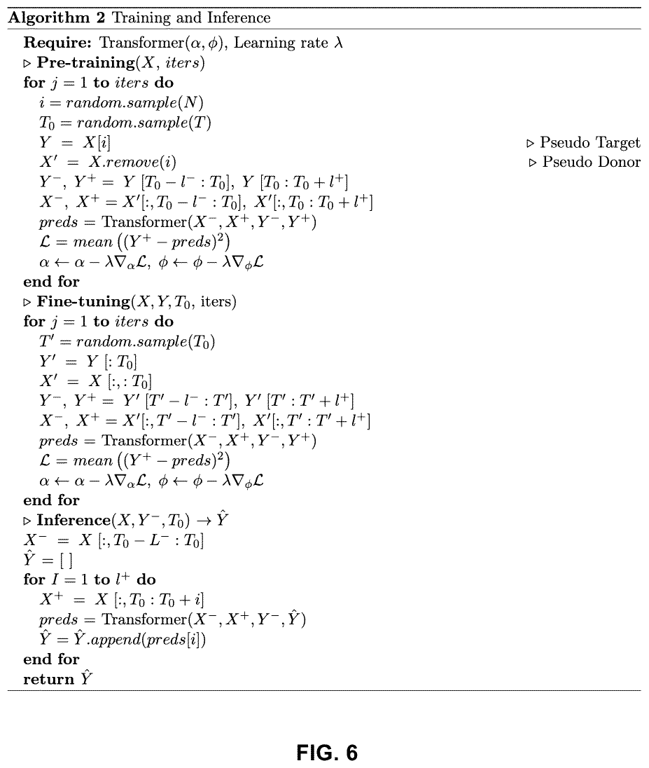

The SC Ŷ may be generated in a sliding window fashion, where it starts at T₀ and generates post-intervention data of temporal length l⁺ each time. The generated control is used as pre-intervention data for the subsequent time steps. Algorithm 2 (see FIG. 6) shows the pseudo-code for training and inference.

Referring to FIG. 2, the method may include sending (270) the autoregressively generated synthetic control to a requestor computing device.

### Example 1—Analyzing Public Health Policy: California Proposition 99

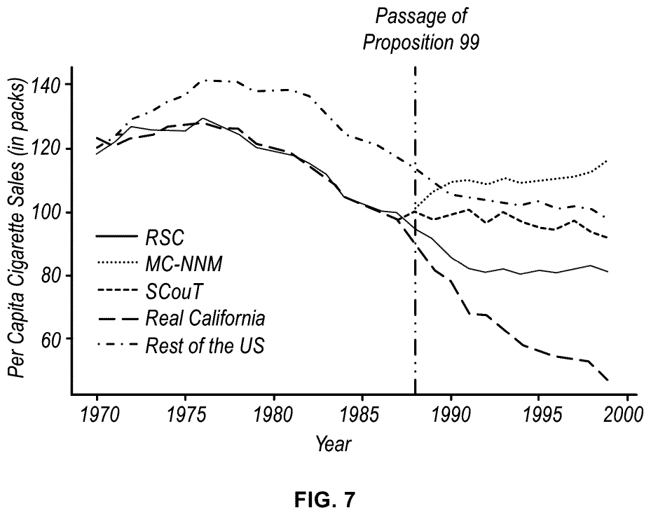

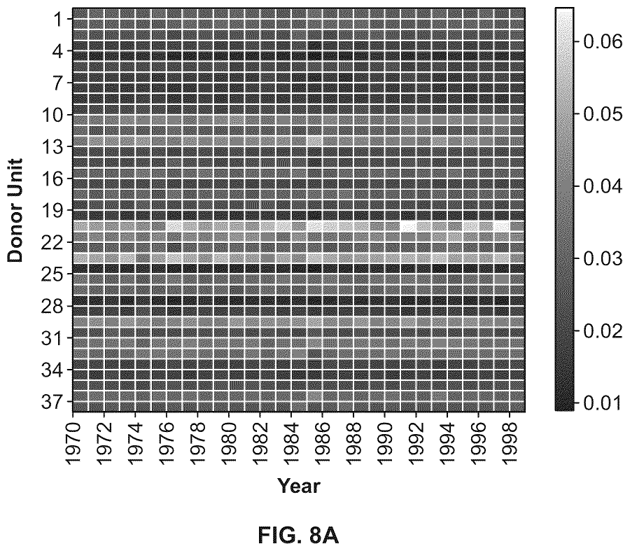

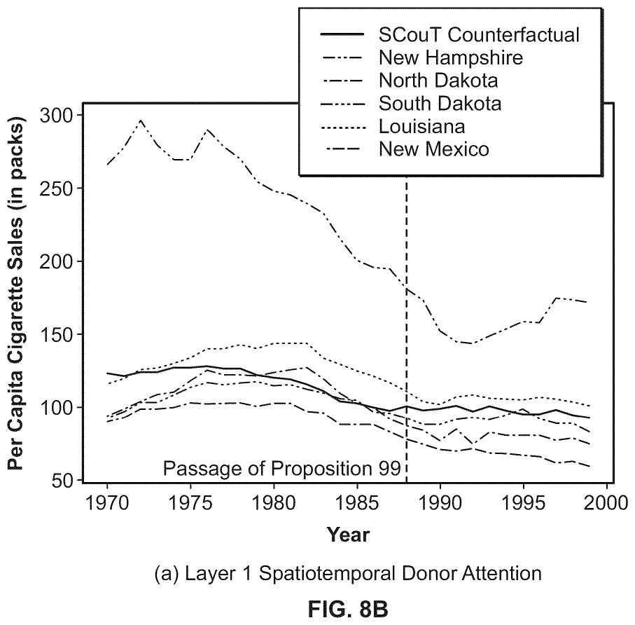

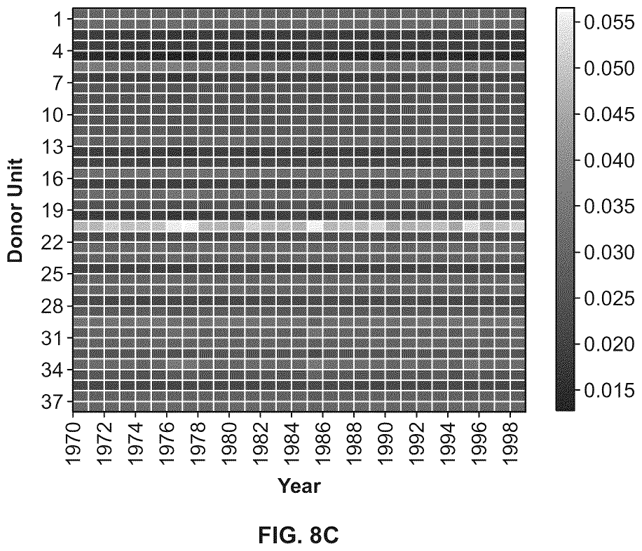

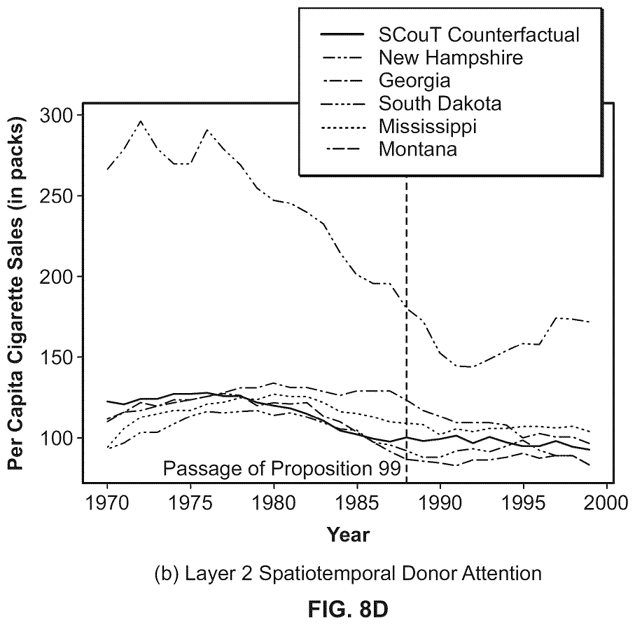

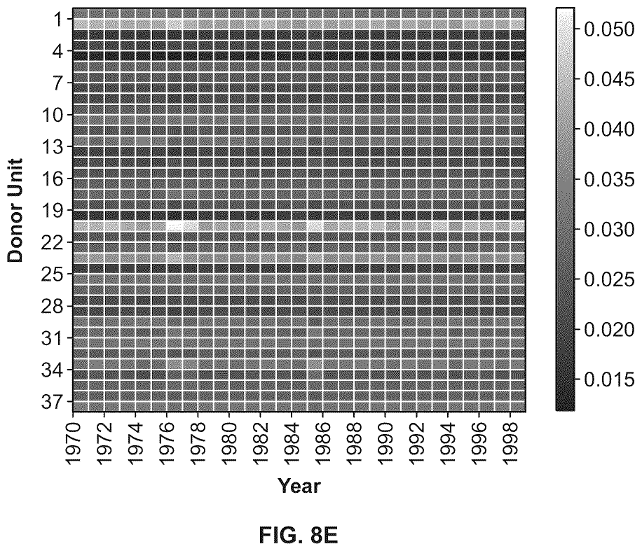

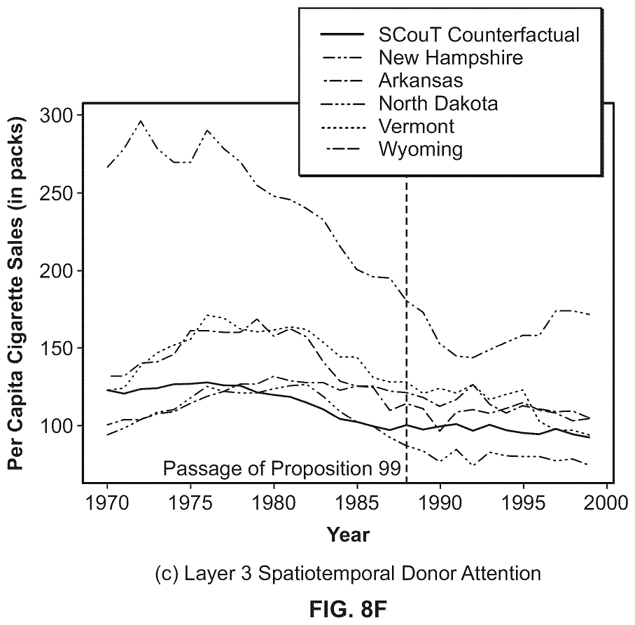

In 1988, California became the first in the United States to pass a large anti-tobacco law, Proposition 99, that hiked the excise tax on cigarette sales by 25 cents. To evaluate the effectiveness of this law, a synthetic California without Proposition 99 was constructed, and the per capita cigarette sales were measured in this synthetic unit. The donor pool consists of 38 control states where no significant policies for tobacco control were introduced and additional covariates like beer consumption, population, and income are included. FIG. 7 compares the California counterfactual prediction of our method and various baselines, all showing that the cigarette sales would have been higher in the absence of the law. One can infer that per-capita cigarette sales fell by 45 packets in real California towards the year 2000 compared to synthetic California. Moreover, the model makes the intuitive prediction that in the absence of the law, cigarette sales in California would converge to the national average. Attention scores of the model can be used to extract the contribution of the donors in making the counterfactual prediction. These weights across the donor space and time are illustrated in FIGS. 8A-8F, indicating the combination that best reproduces the outcome before the passage of Proposition 99.

### Example 2—Random Drug Trials

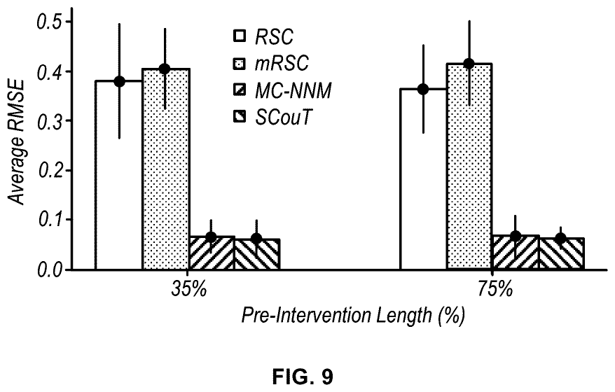

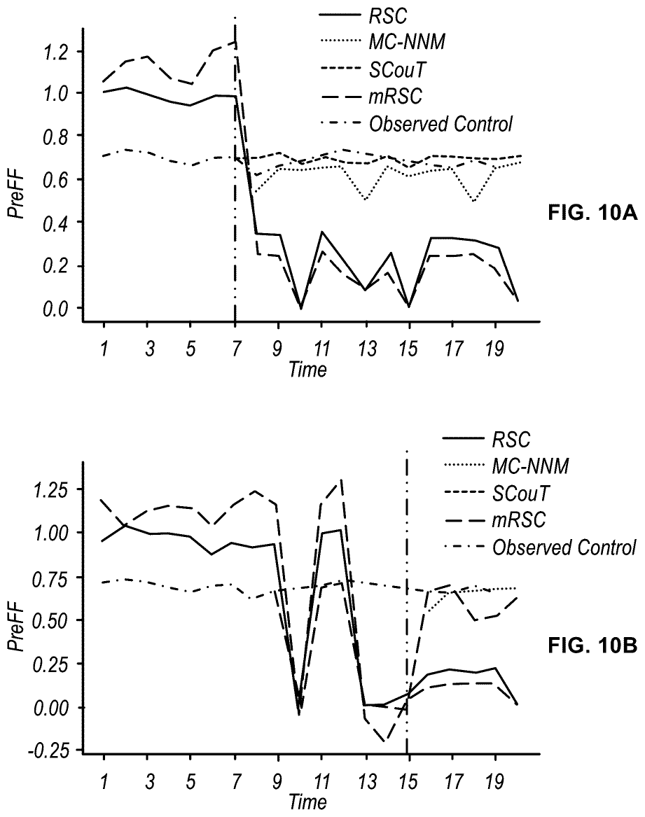

At the patient level, the synthetic counterfactual is a dynamic, virtual representation of the human being over time and enables applications for in silico clinical trials. As an ex-ample, we look at The Childhood Asthma Management Program (CAMP), an RCT designed to study the long-term pulmonary effects of three treatments (budesonide, nedocromil, and placebo) on children with mild-to-moderate asthma. The trial's placebo arm contains anonymized longitudinal data of 275 patients with over 20 spirometry measurements per patient. Pre-Bronchodilator Forced Expiratory Volume to Forced Vital Capacity ratio (PreFF) is a vital metric of lung capacity in Asthma patients that measures volume of air that an individual can exhale during a forced breath prior to the usage of a bronchodilator. Here, the control arm of the RCT was modeled and the PreFF of a target patient was predicted using the other placebos as donors. Two settings were considered, where pre-intervention lengths are 35% and 75% of the total trajectory. One at a time, one patient was set as the target unit and the others considered as donors. In this fashion, the control paths of the first five patients in the placebo arm, the ground truths available, were model. The average RMSE across these patients is reported in FIG. 9. The counterfactual estimates for patients were plotted (only plots for patient 5 are shown in FIGS. 10A and 10B as representative plots). The disclosed method generates a reliable control along with MC-NNM whereas estimates produced by RSC and mRSC are highly biased. It is posited that local spatiotemporal mapping is reasonably effective in controlling for time-dependent confounders, whereas linear estimators that assign time-agnostic weights suffer significantly.

### Example 3—A Case Study on Friedreich's Ataxia (FA)

FA is a fatal degenerative nervous system disorder with no cure. As a progressive disease with a wealth of available data and a growing number of potential therapeutic interventions, FA is one of the many genetic diseases that can benefit from precision medicine. This example uses clinical data collected during the FA Clinical Outcome Measure Study (FA-COMS) cohort, a natural history study involving yearly assessments of a core set of clinical measures and quality of life assessments and maintained by the Critical Path Institute. 163 metrics were included in our model based on clinical relevance and minimal missing data. Each metric can be classified as 1) either longitudinal or static and 2) binary, ordinal, categorical, or continuous. Prior works only consider continuous data and unlike the generalized SCouT framework are therefore, not amenable to categorical data. A recent study found that Calcitriol, the active form of vitamin D, is able to increase Frataxin levels and restore mitochondrial function in cell models of FA. FA is caused by a deficiency of Frataxin, Accordingly, Calcitriol supplements could potentially improve health outcomes for FA patients. This example explores the effect of Calcitriol as an example of a synthetic medical intervention.

The resulting dataset tailored for the Calcitriol synthetic intervention analysis included N=21 donor units who indicated that they were taking a Calcitriol supplement at some point during the study and had sufficient pre-intervention data for training. The dataset was aligned such that every donor patient began taking the supplement at T₀=8. A few patients never indicated that they had taken the supplement during the study period; hence, these patients were set as the target unit and the counterfactual simulated the situation under which the patients do receive treatment at T₀. It is important to note that unlike randomized controlled trials, where one can evaluate the effect of a treatment on the average individual, the synthetic intervention presents the predicted treatment effect on an individual patient, in line with the goals of precision medicine. Imagine a FA patient walking into a clinic, where the physician has access to data from patient's previous health records and is deciding whether or not to recommend a Calcitriol supplement. The physician can use the synthetic intervention technique to generate a counterfactual under this treatment for any desirable metric, as is demonstrated next.

The patients were evaluated on several rating scales commonly used for FA patients:

The FA Rating Scale neurologic examination (FARSn) is one of the most used tests to evaluate an FA patient's disease progression. It involves scoring on several subscales broadly divided into bulbar, lower limb, upper limb, peripheral nervous system and upright stability functionalities.

The Nine-Hole Peg Test (9-HPT) is a quantitative measure of finger dexterity and is conducted on both the dominant and non-dominant arm, in that order. The patient is told to pick up and place pegs into open holes on a board in front of them.

The Activities of Daily Living (ADL) Scale is widely used to rank adequacy and independence in basic tasks that a person could expect to encounter every day, including grooming, dressing, walking, and drinking.

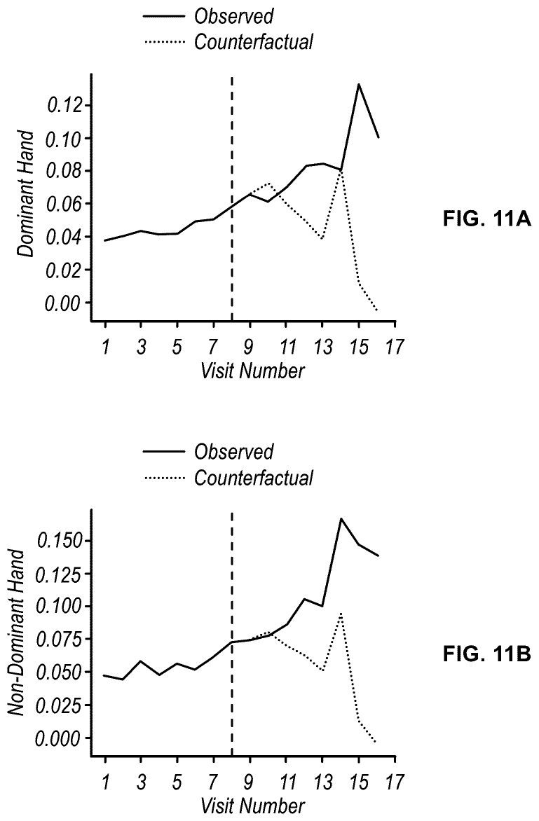

The predictions under the counterfactual scenario where the patients begin to take a Calcitriol supplement at time T₀ are compared against the true observed values for the patients with no intervention. Metrics from the FARSn, 9-HPT, and ADL exams that demonstrated the counterfactual under Calcitriol use for the patients were produced, including predictions for FARSn, ADL, and 9-HPT scales. FIGS. 11A and 11B (showing predictions for an individual under the 9-HPT metric scale) are shown as a representative figure. Most counterfactuals seem to suggest that Calcitriol use would have been beneficial with respect to all metrics considered.

Across specific metrics and select patients, comparing the Calcitriol counterfactual and observed patient values also predicted little benefit from the supplement or were otherwise difficult to extract qualitative meaning from. Finally, none of the comparisons indicated that Calcitriol would allow further disease progression in the patients, which is comforting evidence that, at worst, Calcitriol has little effect. At best, the supplement could greatly improve the quality of life for a patient with FA.

As will be recognized by those skilled in the art, the disclosed approach is applicable in any longitudinal decision-making problem. The method may therefore include making a decision based on the synthetic counterfactuals, and then performing an action to execute that decision (e.g., making a decision on a marketing strategy, then executing the marketing strategy by, e.g., producing marketing materials aligned with the strategy, etc.). For example, healthcare institutions can use SCouT to aid physicians for planning a medical treatment. Additionally, companies may be interested in multimodal healthcare counterfactuals, and SCOUT can be used in a straightforward way to generate counterfactuals. To be precise, healthcare device companies can potentially use SCouT to generate counterfactual audio, images and video using multimodal tokens. Software companies can use SCouT to increase the speed of A/B testing on products. Advertisement companies can use SCouT to do targeted advertising to, e.g., predict advertisement outcomes. Inventory management companies can forecast retail demand using SCouT. The disclosed approach can also be used as a commercial application that's easily downloadable onto smart phones or smart watches. Technology companies (e.g., Apple, Samsung, Fitbit) may directly utilize the SCouT framework in their products to predict user outcomes under various interventions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed:

1. A method for estimating a counterfactual, comprising:
defining an intervention for a target unit and selecting an intervention target unit;
collecting pre-intervention data and post-intervention data from donor units that underwent the intervention;
flattening the pre-intervention data and the post-intervention data from the donor units into sequences;
linearly embedding the sequences to form linearly embedded sequences;
forming a sequence of vectors by injecting temporal embeddings, spatial embeddings, and target embeddings to the linearly embedded sequences; and
passing the sequence of vectors to a Transformer-based encoder-decoder model, the Transformer-based encoder-decoder model configured to use a causal map and enables spatial bidirectionality to autoregressively generate a synthetic control of the target unit.

2. The method of claim 1, wherein the Transformer-based encoder-decoder model includes an encoder configured to compute a hidden representation for the pre-intervention data and send the hidden representation to a decoder.

3. The method of claim 2, wherein the decoder is configured to use the hidden representation and the post-intervention data to autoregressively generate the synthetic control.

4. The method of claim 1, further comprising making a decision based on the synthetic control.

5. The method of claim 4, further comprising performing an action to execute the decision.

6. The method of claim 1, further comprising using the synthetic control to plan a medical treatment.

7. The method of claim 1, further comprising using the synthetic control to increase a speed of A/B testing.

8. The method of claim 1, further comprising using the synthetic control to predict advertisement outcomes.

9. A system comprising;
at least one processing unit; and
at least one non-transitory computer readable storage medium storing instructions that, when executed by the at least one processing unit, cause the at least one processing unit to, collectively:
send an estimated counterfactual request to a provider computing device from a requestor computing device; the estimated counterfactual request containing a proposed intervention containing pre and post temporal data of a target unit;
collect pre-intervention and post-intervention data from donor units;
flatten and linearly embed the pre-intervention and post-intervention data from donor units into sequences;
add positional information in a form of temporal and spatial embeddings;
distinguish between target and donor units by injecting a target embedding;
pass a resultant sequence of vectors to a Transformer-based encoder-decoder model;
use a causal map, which enables spatial bidirectionality, to autoregressively generate a synthetic control of the target unit; and
send the synthetic control to the requestor computing device.

10. A non-transitory computer readable medium, comprising instructions thereon that, when executed by at least one processing unit, cause the at least one processing unit to, collectively:
send an estimated counterfactual request to a provider computing device from a requestor computing device; the estimated counterfactual request containing a proposed intervention containing pre and post temporal data of a target unit;
collect pre-intervention and post-intervention data from donor units;
form a sequence of vectors by flattening and linearly embedding the pre-intervention and post-intervention data from donor units, adding positional information in a form of temporal and spatial embeddings, and distinguishing between target and donor units by injecting a target embedding;
pass the sequence of vectors to a Transformer-based encoder-decoder model;
use a causal map, which enables spatial bidirectionality, to autoregressively generate a synthetic control of the target unit; and
send the synthetic control to the requestor computing device.
